(19) United States
(12) Patent Application Publication
(10) Pub. No.: US 2017/0009590 A1
(43) Pub. Date: Jan. 12, 2017

(54) ORIFICE ELEMENT FOR TURBINE STATOR AND/OR ROTOR VANES

(71) Applicant: Siemens Aktiengesellschaft, Munich (DE)

(72) Inventor: Ulf Nilsson, Whetstone (GB)

(73) Assignee: Siemens Aktiengesellschaft, Munich (DE)

(21) Appl. No.: 15/189,260

(22) Filed: Jun. 22, 2016

(30) Foreign Application Priority Data
Jul. 6, 2015 (EP) 15175478.5

(51) Int. Cl. F01D 5/18; F01D 25/12; F01D 9/04

(52) U.S. Cl. CPC F01D 5/187; F01D 9/041; F01D 25/12; F05D 2220/32; F05D 2260/202

(57) ABSTRACT

An orifice element is adapted to be inserted into a recess formed at an external opening of a channel in a turbine stator or rotor vane, the channel being adapted for leading a cooling fluid through the vane. The orifice element has a mounting part formed of a solid material, and an opening part leaving an opening between a first side of the orifice element and a second side of the orifice element, the second side being opposite to the first side.

### CROSS REFERENCE TO RELATED APPLICATIONS

This application claims the benefit of European Application No. EP15175478 filed 06 Jul. 2015, incorporated by reference herein in its entirety.

### FIELD OF INVENTION

The invention relates to an orifice element for turbine stator and/or rotor vanes, for example blades or vanes of a steam or gas turbine.

### BACKGROUND OF INVENTION

Turbine vanes, such as turbine stator vanes or rotor vanes, the latter being also known as turbine blades, are subjected during operation in a gas or steam turbine to hot gas or steam. Thus, there is a need for an active cooling, which is achieved by passing a cooling fluid such as air through internal passages of the vanes known as cooling channels.

The pressure drop and the flow-rate of the cooling fluid is determined by the internal geometry of each vane and in particular of its cooling channels, and may vary depending on manufacturing tolerances affecting, for example, the cross-sectional apertures of the cooling channels. Further, the same type of vane may be used in different types or versions of turbines, and further in different fields of operation, which may result in different firing temperatures, steam temperatures and/or different life requirements. Thus, varying demands regarding the flow of the cooling fluid may exist.

In view of these varying demands, vanes are typically manufactured to match the highest cooling demands. For example, cross-sectional apertures of the cooling channels are determined sufficiently large for guaranteeing a sufficient flow of cooling fluid even under the hottest firing temperatures to be expected. This, however, results in a loss of performance. In particular, cooling fluid or cooling air mixes, when leaving the turbine vane, to the hot gas in the turbine and thus reduces its energy level. Further, cooling air is often drawn from the compressor, thereby reducing pressure and energy of the compressed air.

### SUMMARY OF INVENTION

Accordingly, there is a need for providing turbine stator and/or rotor vanes having a better efficiency, improving the performance and power output of turbines under varying conditions, while on the other hand meeting given life requirements.

These objects are solved by an orifice element, a turbine stator or rotor vane, a kit of parts comprising a turbine stator or rotor vane and a least one orifice element, a method of manufacturing an orifice element and a method of selecting and/or calibrating an orifice element according to the independent claims. Further embodiments are described in the dependent claims.

An orifice element is adapted to be inserted into a recess formed at an external opening of a channel in a turbine stator or rotor vane, the channel being adapted for leading a cooling fluid through the vane. The orifice element has a mounting part formed of a solid material, and an opening part providing an aperture between a first side of the orifice element and a second side of the orifice element, the second side being located opposite to the first side.

The term “vane” is used herein for turbine stator vanes and/or turbine rotor vanes. Further, turbine rotor vanes may also be referred to as blades in the following, as is common sometimes. It should be noted that the orifice element is adapted for use in turbine stator and rotor vanes, i.e. turbine blades and vanes, and further adapted for use in any kind of turbine, such as gas turbines, steam turbines or the like.

The cooling channel may be adapted, for example, to be used for air cooling or fluid cooling. It may lead through the vane with any kind of geometry, and may be adapted for convection cooling, impingement cooling film cooling and/or effusion cooling of the vane.

The orifice element may be adapted for being inserted at the external opening of the channel, where the recess may be formed specifically for receiving the orifice element. To be fixed within the recess, the orifice includes the mounting part which is formed of the solid material and allows placing and holding the orifice element within the recess. Thus, the mounting part allows a secure mounting and fixing of the orifice element at the opening of the cooling channel.

When being placed within the recess, the opening part provides an aperture or opening of the orifice, the aperture extending between the first and second sides of the orifice element, which sides are located opposite to each other. Thus, the aperture allows the cooling fluid to pass through the orifice element, e.g. when entering or being sucked or drawn into the channel. Thus, the opening part allows the cooling fluid to pass the orifice element and thus to enter the channel for cooling the vane.

Accordingly, the aperture of the orifice element forms and modifies the opening of the cooling channel. It allows modifying the opening by adapting and limiting the cross-sectional aperture of the inlet to the channel. Thus, when using the orifice element, the mass flow of cooling fluid through the cooling channel is adapted and controlled by the orifice element.

This permits adapting the mass flow in accordance with a particular cooling need of the vane, e.g. in a particular version of the turbine, in a particular field of application, corresponding to an intended firing temperature and/or to a life requirement. Thus, the flow of cooling fluid may be adapted such that an optimum performance, efficiency and power output from the turbine is achieved while an optimum or pre-specified maximum blade temperature is not exceeded.

Further, it is possible to adapt the cooling fluid consumption of an individual vane so as to deliver an optimal vane temperature for a given application, e.g. at a specific mounting position within the turbine. Thus, overall power output and efficiency of the turbine are maximized.

Still further, if a vane has a cooling channel with a cross-sectional aperture outside a given tolerance, e.g. due to a manufacturing error, the vane may be salvaged or repaired by using the orifice element, thereby adapting the cross-sectional aperture at the entrance to the channel. Thus, manufacturing scrap is reduced and manufacturing output enhanced.

In a further embodiment, the mounting part forms a surrounding enclosure defining at least one lateral side of the orifice element, and the opening parts forms a passage from the first side of the second side, the passage being surrounded by the surrounding enclosure.

The passage formed by the opening part may be located essentially in the middle of the surrounding enclosure, allowing the cooling fluid to pass through the opening part and thus to enter the channel. The mounting part may be used as a frame for placing, holding and fixing the orifice element within the recess, defining the at least one lateral side to be retained within the recess.

In another embodiment, the first side and the second side respectively include surfaces extending essentially in parallel to each other. Further in this embodiment, the at least one lateral side may form a cylinder having a circular base, an elliptic base, an ovoid base, a polygonal base or an irregular base, the base being formed by the first and second sides.

Thus, the orifice element may be of an essentially cylindrical shape with the opening part forming the passage through e.g. the middle. This allows on the one hand to easily manufacture the orifice element, and on the other hand to securely place and hold it within the recess at the entrance of the cooling channel of the vane.

In a further embodiment, the passage is delimited by inner walls of the surrounding enclosure, the inner walls forming one or more consecutive sections of the passage, wherein at least one of the sections is formed by one of a group comprising a cylinder having a circular base, an elliptic base, an ovoid base, a polygonal base or an irregular base and a cone section or a pyramid section having a circular base, an elliptic base, an ovoid base, a polygonal base or an irregular base.

Thus, if the passage is formed of only one section, the section may be of cylindrical shape with any kind of base, providing a constant cross-sectional aperture throughout the passage. Alternatively, the section may also have the form of a cone section or pyramid section with the apex cut, thus providing a cross-sectional aperture reducing or increasing along the section. Further, several sections may be arranged consecutively while, however, providing a continuous passage through the orifice element.

By varying the geometry and arrangement of the inner walls of the surrounding enclosure, the inlet of the cooling fluid may be controlled, e.g. such that a predefined maximum cross-sectional opening is not exceeded, and/or such that turbulences may be generated within the cooling fluid at the entrance of the channel.

A turbine stator vane or turbine rotor vane has a channel being adapted for leading a cooling fluid through the vane and a recess formed at an external opening of the channel, the recess being adapted to receive an orifice element forming an orifice to the channel. The orifice element may have any of the features described above.

The turbine stator or rotor vane may be a blade or vane of any kind of turbine, such as a gas turbine, a steam turbine or the like. As cooling fluid, air and/or a different fluid may be used, e.g. a cooling liquid. The channel may be adapted for any kind of cooling flow, such as convection cooling or impingement cooling. The external opening at which the recess is formed may be arranged at an inlet, through which during operation, the cooling fluid enters the channel.

The recess may be adapted to receive the orifice element, which allows adapting the inlet of the cooling fluid in particular in view of a cooling need in different versions of the turbine, different fields of application, different firing temperatures and/or under presence of different life requirements. Thereby, the cooling air consumption of the individual blade may be adapted so as to deliver an optimal blade temperature for a given application. Accordingly, the power output and efficiency of the turbine is maximized while cooling requirements are fulfilled. Further, vanes having cross-sectional apertures of their channels slightly outside tolerance may be salvaged by applying the orifice element, which vanes would otherwise be scrapped.

In an embodiment of the vane, the recess is formed so as to achieve a positive fitting, a form-locked fitting and/or a thermal shrink fitting with the orifice element.

Thus, the geometry and size of the recess may be formed in correspondence to a geometry and size of the orifice element, in particular a geometry and size of the at least one lateral side and the first side, which sides may be brought in contact with the walls of the recess.

This allows to easily apply and fix of the orifice element within the recess. Further, the positive or form-locked fitting provides for a close fit with minimum clearance, such that the fixing is stable during operation, and such that the cooling fluid is forced to enter the channel via the opening part or passage of the orifice element. Thus, the mass flow of cooling fluid entering the channel may be controlled by the orifice element.

Further, a thermal shrink fitting of the orifice element may be achieved by heating the blade before and/or during installation of the orifice element, thereby achieving a close and permanent fit.

In a further embodiment of the vane, the vane is a turbine rotor vane, in particular a turbine blade, and the recess is formed in a bottom of the root of the turbine rotor vane.

In an alternative embodiment, the vane is a turbine stator vane and the recess is formed in an inner shroud or in an outer shroud of the vane.

According to these embodiments, the recess is formed and the orifice element may be placed at an inlet of the channel of the vane, which inlet is arranged at the root or inner or outer shroud of the vane.

A former embodiment is formed of a kit of parts comprising a turbine stator or rotor vane as discussed in the above, and at least one orifice element as discussed in the above.

Thus, not only a single, but also a plurality of cooling channels and in particular all of the cooling channels in the vane may be foreseen with an orifice element, placed e.g. at the inlet of the respective vane. Thus, the complete cooling flow through the vane may be controlled by the orifice elements. These may be selected individually in view of the specific cooling channel at which they are placed and in view of a need for a cooling flow through this specific channel, and/or in view of the overall cooling need of the vane.

In a further embodiment of the kit of parts, the at least one orifice element may be formed of a same material as the vane.

In an alternative embodiment the orifice element may be formed of a different material as the vane, the material of the orifice element being selected so as to support the thermal shrink fitting to the vane.

If the orifice element is formed of the same material as the vane, in particular of the same material as the root base or shroud of the vane where the recess is located, a stable fixing may be achieved. This is due to a corresponding extension of these parts under operating conditions and temperatures. If, however, different materials are used, these may be selected such that the fitting is close and secure under operation conditions.

In a method of manufacturing an orifice element, the orifice element is adapted to be inserted into a recess formed at an external opening of a channel in a turbine stator or rotor vane, which channel is adapted for leading a cooling fluid through the vane. In this method, the orifice element has a mounting part formed of a solid material and an opening part leaving an aperture between a first side of the orifice element and a second side of the orifice element, the second side being opposite to the first side. The method includes manufacturing the orifice element by a conventional manufacturing process including a casting, a molding, a forming, and/or a machining, and/or manufacturing the orifice element by an additive manufacturing process, a selective laser sintering process and/or a direct metal laser sintering process.

The orifice element may thus be manufactured in a conventional manner.

However, the orifice element may also be manufactured using an additive manufacturing process using the mentioned techniques, which allow forming the orifice element exactly as defined e.g. in a dataset provided by a Computer-aided design software so as to closely fit the recess.

In a method of selecting and/or calibrating an orifice element, the orifice element is adapted to be inserted into a recess formed at an external opening of a channel in a turbine stator or rotor vane, the channel being adapted for leading a cooling fluid through the vane. Within the method, the orifice element has a mounting part formed of a solid material and an opening part leaving an opening between a first side of the orifice element and a second side of the orifice element, the second side being opposite to the first side. The method includes inserting the orifice element into the recess so as to achieve a close fit between the orifice and the recess, supplying the cooling fluid through the orifice element by varying a setting value, measuring an observation value and comparing the observation value to a target value.

The method allows selecting an orifice element in view of a cooling fluid consumption which may be defined as necessary for the cooling channel or vane within an application of the turbine. Accordingly, the cooling fluid consumption of the vane may be calibrated by selecting an appropriate orifice element. Further, performance of a selected orifice element may be evaluated using the method.

To achieve these goals, the orifice element is inserted into the recess, whereby a close fit with a minimal clearance is achieved. Then, the cooling fluid is supplied to the channel via the orifice element, passing through its aperture. The supply of the cooling fluid may be varied by varying the setting value, while the observation value is measured and compared to the target value. Based on the comparison, a selection of the orifice element may be determined, a performance of the orifice element may be evaluated and/or the cooling fluid consumption of the vane may be calibrated.

In an embodiment of the method, the setting value may be a mass flow through the channel and the observation value may be a feed pressure at the orifice element. Alternatively, the setting value may be the feed pressure at the orifice element and the observation value may be the mass flow through the channel.

Thus, the orifice element may be selected or evaluated or the cooling air consumption of the vane may be calibrated by varying the mass flow through the channel, observing the feed pressure, or alternatively by varying the feed pressure at the orifice element, observing the mass flow trough the channel. Thus, the cooling fluid consumption may be evaluated for example under operating conditions.

In a further embodiment, the method may include determining a starting temperature of the vane and/or a starting temperature of the cooling fluid and observing a temperature change of the vane.

Thus, the selection, evaluation and/or calibration may also be performed under different operating conditions regarding the temperature on the one hand of the cooling fluid and on the other hand of the vane, which vane may be to be heated or cooled. The temperature change during the application of the cooling fluid may be compared for example to a target temperature change.

In a further embodiment, a correlation table may be determined based on the setting value, the observation value, the starting temperature of the vane, the starting temperature of the cooling fluid, the temperature change of the vane and/or a cross-sectional aperture of the orifice element. The method may further include selecting an orifice element based on predetermined operating conditions according to the correlation table.

Thus, the calibration process may result in a large number of measurement results, which may be organized in the correlation table. The correlation table may be generated and managed manually or as a part of a calibration software. Based on the correlation table, it is possible to determine a suitable orifice element in view of operation conditions and cooling needs in a given environment or field of application.

In a further embodiment, the method includes selecting a further orifice element having a different cross sectional aperture, and repeating the method using the further orifice element as the orifice element.

Thus, the selection, evaluation and calibration method may be performed repeatedly using orifice elements with different cross-sectional apertures for identifying for example an orifice element being most suitable e.g. in a specific turbine and/or field of application.

The described embodiments, together with the further advantages, will be best understood by reference to the following detailed description taken in conjunction with the accompanying drawings. The elements of the drawings are not necessarily to scale relative to each other.

### BRIEF DESCRIPTION OF THE DRAWINGS

FIG. 1 illustrates an embodiment of a turbine rotor vane,

FIG. 2 illustrates a cross-sectional view of the turbine rotor vane of FIG. 1,

FIG. 3 illustrates a bottom view of the root part of the turbine rotor vane having cooling air inlets with orifice elements,

FIG. 4 illustrates cross-sectional views of orifice elements,

FIG. 5 illustrates possible shapes of opening parts of orifice elements, and

FIG. 6 illustrates an embodiment of a method for selecting an orifice element and/or calibrating a cooling fluid consumption of a turbine rotor or stator vane.

### DETAILED DESCRIPTION OF INVENTION

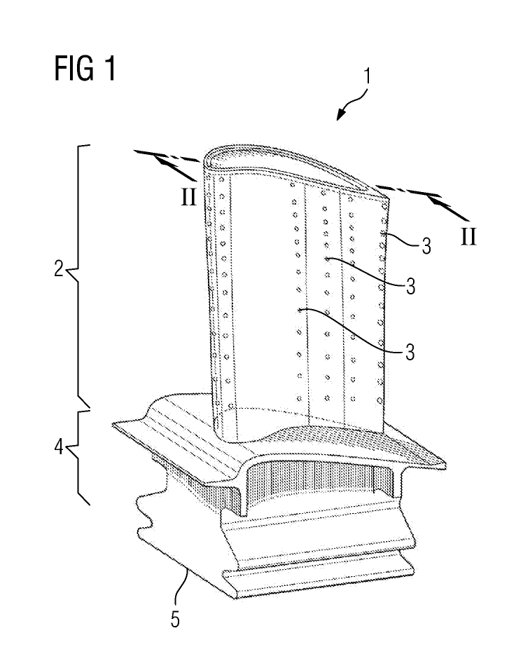

Referring now to the drawings, wherein like reference numerals designate identical or corresponding parts throughout the several views, FIG. 1 illustrates an embodiment of a turbine rotor vane, referred to as blade 1.

Blade 1 has an upper part 2 which may be exposed to the hot gas or steam during operation. Along and around upper part 2, core exit holes 3 are distributed, through which during operation a cooling fluid may exit from internal channels of blade 1. The exhalation of the cooling fluid allows forming a cooling film on at least parts of the surface of the upper part 2 of blade 1. Further, blade 1 has a root part 4 having a fir-tree profile adapted for being inserted e.g. in a slot of corresponding shape of a rotor part of a turbine, the root part 4 having at its bottom a root base 5.

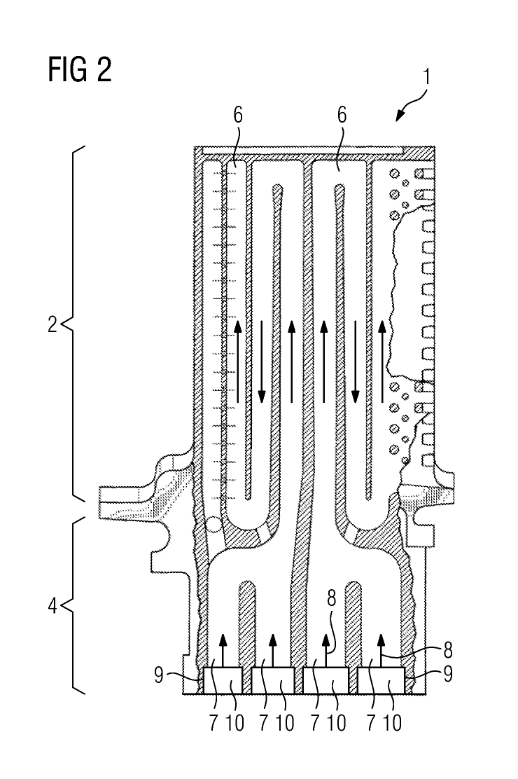

A sectional side view of blade 1 along a sectional line II is shown in FIG. 2. In this Figure, a possible internal geometry of blade 1 and a possible arrangement of channels 6 leading cooling fluid through blade 1 is illustrated. The channels 6 have openings 7 perforating root base 5, through which the cooling fluid may enter the channels 6 during operation, as illustrated by arrows 8. At the openings 7, recesses 9 have been hollowed out from root part 4 at root base 5, into which recesses 9 orifice elements 10 have been inserted, through which orifice elements 10 the cooling fluid may enter the channels 6 during operation.

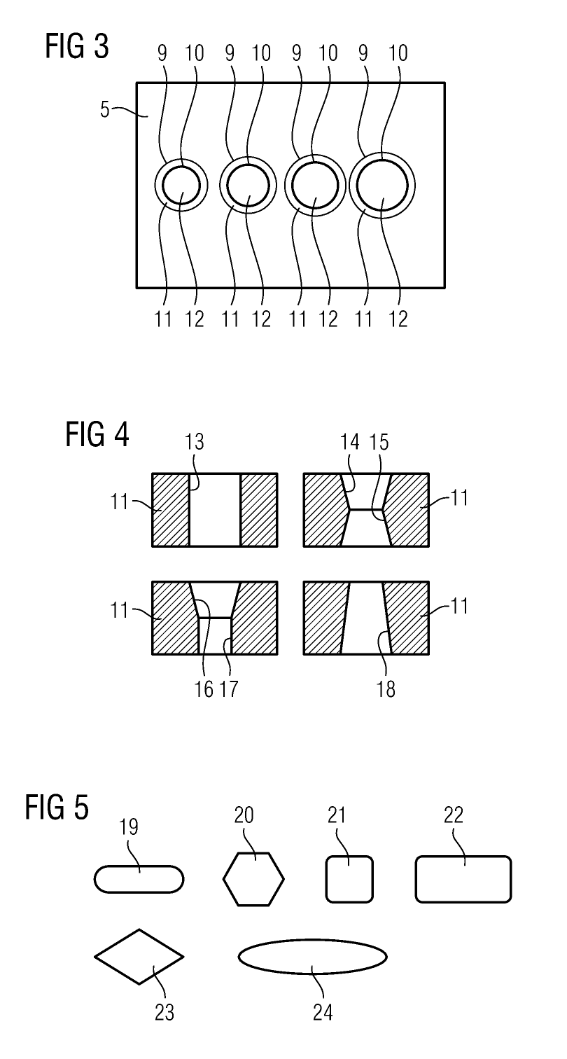

FIG. 3 illustrates a bottom view of root part 4 showing a view on root base 5 with recesses 9, into which the orifice elements 10 are inserted. Each orifice element 10 has a mounting part 11 formed of a solid material, forming a surrounding enclosure defining a lateral side of the respective orifice element 10, surrounding the respective orifice element 10 cylindrically, i.e. in form of a cylinder having a circular base. Further, each orifice element 10 has an opening part 12 providing an aperture between a first side of the respective orifice element 10, the first side being inserted into a respective recess 9 in a direction of a respective channel 6, and a second side being located opposite o the first side, closing up smoothly with root base 5. Thus, the opening parts 12 form passages from the first sides to the second sides, the passages being respectively surrounded by the mounting parts 11.

FIG. 4 illustrates sectional side views on four different types of orifice elements 10. Within each type, the opening part 12 is delimited by an inner wall or inner walls of the mounting part 11, the inner walls forming one or more consecutive sections 13 to 18 of the respective opening part 12. The sections 13, 17 may be formed as a cylinder having a circular base, and elliptic base, an ovoid base, a polygonal base or an irregular base, as shown in the upper left example of FIG. 4. Furthermore, the sections 13 may also be formed as cone sections or pyramidal sections 14, 15, 16, 18 having a circular base, an elliptic base, an ovoid base, a polygonal base or an irregular base, as shown in the upper right example and in the lower examples of FIG. 4.

The orifice elements 10 may thus have different cross-sectional apertures, which cross-sectional apertures are illustrated in the examples of FIG. 5. The cross-sectional apertures may accordingly be formed as a slot 19, a regular hexagon 20, a square with rounded corners 21, a rectangle with rounded corners 22, a rhomb 23 or an ellipse 24.

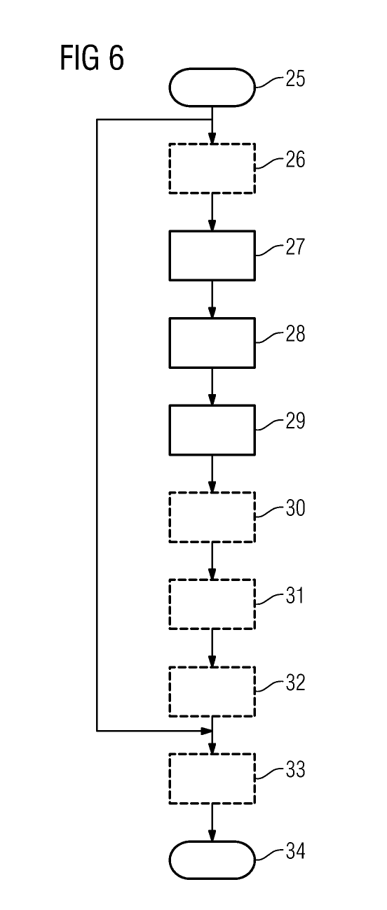

FIG. 6 illustrates a method for selecting an orifice element 10 and/or of calibrating a cooling fluid consumption of a turbine rotor or stator vane, such as blade 1, wherein the orifice element 10 is adapted to be inserted into a recess 9 formed at an external opening of a channel 6 adapted for leading the cooling fluid through blade 1. As set out in the above, the orifice element 10 according to the method has a mounting part 11 formed of a solid material, and an opening part 12 leaving an opening between the first side and the second side of orifice 10. Optional steps of the method are surrounded by dashed lines, while mandatory steps are surrounded by continuous lines.

After beginning 25, a starting temperature of blade 1 and/or of the cooling fluid may be determined at 26. At 27, an orifice element 10 having e.g. a passage of a predetermined cross-sectional aperture and shape may be selected and inserted into one of the recesses 9 of blade 1.

At 28, the cooling fluid is supplied to the cooling channel 6 through the orifice element 10 by varying a setting value, e.g. a mass flow through the cooling channel 6 or a feed pressure at the orifice element 10.

At 29, an observation value may be measured and compared to a target value. The observation value may for example be the feed pressure at the orifice element 10 if the mass flow through the channel 6 was selected as the setting value. Further, the observation value may also be the mass flow through the channel 6, if the setting value was the feed pressure at the orifice element 10.

Further, at 30, a temperature change of blade 1 may be observed, in particular in view of a starting temperature of blade 1 and/or of the cooling fluid.

At 31, a correlation table may be determined based on the determined and observed values, the correlation table depending for example on the setting value and the observation value, the starting temperature of blade 1, the starting temperature of the cooling fluid, the temperature change of blade 1 and/or a cross-sectional aperture of the orifice element 10. Any of these parameters may be varied, while any the others may be observed.

At 32, a further orifice element 10 may be selected, e.g. having a different cross-sectional aperture. Using the further orifice element 10, the method may be repeated, e.g. by restarting at 26. Steps 26 to 32 thus may be repeated until one of the orifice elements 10 may be determined or selected, at 33, as being well-suited or adapted for a given application. With this selection, the calibration and selection method may end at 34.

During the calibration method, measurement nominal orifices 10 may be used e.g. for a particular version of blade 1. These measurement nominal orifices 10 may be manufactured so as to have a particularly close fit with minimum clearance within the recesses 9 in root base 4 of blade 1.

By the calibration measurement, orifices 10 having a selected cross-sectional aperture of opening part 12 may be determined and fitted to an embodiment of the blade, e.g. by a shrink fit to blade 1 heated during installation.

From a cost point of view, there is a trade-off between the size of blade 1 and how far the optimisation is driven in the daily production. For smaller blades it may acceptable to use one size for all blades in the same application, e.g. firing temperature. For larger blades it may be advantageous to calibrate each and every blade individually. As a compromise a few samples are taken from the batch delivered from the casting house/supplier and calibrated individually. The orifice element 10 to be used for all blades is then defined based on the sample result.

As the number of measurement results grows, the correlation table which may be determined manually at the beginning may be determined using a calibration software.

Using orifices 10 to adapt the cooling air consumption of an individual blade 1 allows delivering an optimal blade temperature for a given application. The orifice elements 10 may be installed without any machining or welding operation. Using orifice elements 10 allows maximizing the power output and efficiency for a given gas turbine configuration. It may also allow salvaging blades that are slightly outside tolerance and that would otherwise by scrapped.

1. An orifice element for limiting an external opening of a cooling channel, adapted to be inserted into a recess formed at the external opening of the channel in a turbine stator or rotor vane, the channel being adapted for leading a cooling fluid through the vane, the orifice element comprising:
a mounting part formed of a solid material, and
an opening part providing an aperture between a first side of the orifice element and a second side of the orifice element, the second side being located opposite to the first side.

2. The orifice element of claim 1, wherein
the mounting part forms a surrounding enclosure defining at least one lateral side of the orifice element, and
the opening part forms a passage from the first side to the second side, the passage being surrounded by the surrounding enclosure.

3. The orifice element of claim 2, wherein
the first side and the second side respectively include surfaces extending essentially in parallel to each other, and/or
the at least one lateral side forms a cylinder having a circular base, an elliptic base, an ovoid base, a polygonal base or an irregular base.

4. The orifice element of claim 2, wherein
the passage is delimited by inner walls of the surrounding enclosure, the inner walls forming one or more consecutive sections of the passage, wherein at least one of the sections is formed by one of a group comprising:
a cylinder having a circular base, an elliptic base, an ovoid base, a polygonal base or an irregular base, and
a cone section or a pyramid section having a circular base, an elliptic base, an ovoid base, a polygonal base or an irregular base.

5. A turbine stator vane or turbine rotor vane, comprising:
a channel being adapted for leading a cooling fluid through the vane, and
a recess formed at an external opening of the channel, the recess being adapted to receive an orifice element according to claim 1, the orifice element forming an orifice to the channel.

6. The vane of claim 5, wherein
the recess is formed so as to achieve a positive fitting, a form-locked fitting and/or a thermal shrink fitting with the orifice element.

7. The vane of claim 5, wherein
the vane is a turbine rotor vane and the recess is formed in a bottom of a root of the turbine rotor vane, or
the vane is a turbine stator vane and the recess is formed in an inner shroud of the vane or in an outer shroud of the vane.

8. A kit of parts comprising:
at least one orifice element according to claim 1, and
a turbine stator vane or turbine rotor vane comprising:
a channel being adapted for leading a cooling fluid through the vane, and
a recess formed at an external opening of the channel, the recess being adapted to receive the orifice element, the orifice element forming an orifice to the channel.

9. The kit of parts according to claim 8, wherein
the orifice element is formed of a same material as the vane, or
the orifice element is formed of a different material as the vane, the material of the orifice element being selected so as to support the thermal shrink fitting to the vane.

10. A method of manufacturing an orifice element for limiting an external opening of a cooling channel, the orifice element being adapted to be inserted into a recess formed at the external opening of the channel in a turbine stator vane or turbine rotor vane, the channel being adapted for leading a cooling fluid through the vane, the orifice element having a mounting part formed of a solid material, and an opening part leaving an aperture between a first side of the orifice element and a second side of the orifice element, the second side being opposite to the first side, the method comprising:
manufacturing the orifice element by a conventional manufacturing process including a casting, a molding, a forming, and/or a machining, and/or
manufacturing the orifice element by an additive manufacturing process, a selective laser sintering process and/or a direct metal laser sintering process.

11. A method of claim 10, the method further comprising:
inserting the orifice element into the recess so as to achieve a close fit between the orifice and the recess,
supplying the cooling fluid through the orifice element by varying a setting value, and
measuring an observation value and comparing the observation value to a target value.

12. The method of claim 11, wherein
the setting value is a mass flow through the channel and the observation value is a feed pressure at the orifice element or
the setting value is a feed pressure at the orifice element and the observation value is a mass flow through the channel.

13. The method of claim 11 or 12, further comprising:
determining a starting temperature of the vane and/or a starting temperature of the cooling fluid and
observing a temperature change of the vane.

14. The method of claim 11, further comprising:
determining a correlation table based on the setting value, the observation value, the starting temperature of the vane, the starting temperature of the cooling fluid, the temperature change of the vane and/or a cross sectional aperture of the orifice element, and/or
selecting an orifice element based on predetermined operating conditions according to the correlation table.

15. The method of claim 11, further comprising:
selecting a further orifice element having a different cross sectional aperture, and
repeating the method using the further orifice element as the orifice element.
